(19) United States
(12) Patent Application Publication
(10) Pub. No.: US 2004/0195022 A1
(43) Pub. Date: Oct. 7, 2004

(54) Drive control apparatus for vehicle

(75) Inventor: Shigeru Inoue, Utsunomiya-shi (JP)

Correspondence Address: ARENT FOX KINTNER PLOTKIN & KAHN, PLLC, Suite 400, 1050 Connecticut Avenue, N.W., Washington, DC, 20036-5339, US

(73) Assignee: Honda Motor Co., Ltd.

(21) Appl. No.: 10/797,010

(22) Filed: Mar. 11, 2004

(30) Foreign Application Priority Data
Apr. 3, 2003 (JP) 2003-100329

(51) Int. Cl. B60K 31/00; B60K 31/04

(52) U.S. Cl. 180/170

(57) ABSTRACT

A drive control apparatus for a vehicle having an accelerator pedal and a brake pedal both of which are operable by a driver of the vehicle, and a power source. The drive control apparatus includes a vehicle speed measuring device which measures a vehicle speed, a control operation switching device which places the drive control apparatus in an operating state upon receiving an operation from the driver, a vehicle speed adjusting device which is placed in an operating state upon receiving a command from the control operation switching device, and which, during the operating state, automatically adjusts the vehicle speed measured by the vehicle speed measuring device, independently from driver's operations of the accelerator pedal and of the brake pedal, so that a target vehicle speed is achieved, and a target vehicle speed changing device which changes the target vehicle speed depending on predetermined driver's operations of the accelerator pedal or of the brake pedal.

### BACKGROUND OF THE INVENTION

1. Field of the Invention

The present invention relates to a drive control apparatus for a vehicle.

Priority is claimed on Japanese Patent Application No. 2003-100329, filed Apr. 3, 2003, the content of which is incorporated herein by reference.

2. Description of Related Art

A type of cruise control system for a vehicle is known in which whether or not another vehicle precedes the vehicle is determined using a radar, a camera, etc., and when a preceding vehicle is detected, the vehicle is controlled so that the vehicle speed is maintained to be less than or equal to a predetermined upper limit and an inter-vehicle distance with the vehicle ahead is maintained to be a predetermined value, and on the other hand, when a preceding vehicle is not detected, the vehicle is controlled so that the vehicle speed is maintained to be a predetermined upper limit (see, for example, Japanese Unexamined Patent Application, First Publication No. 2002-178787).

Such a cruise control system includes, in addition to a main switch which places the cruise control system in the ON state or OFF state, manually operable switches such as a setting switch which sets an upper speed limit to be, for example, a current vehicle speed, an acceleration switch which increases the currently set upper speed limit, a deceleration switch which decreases the currently set upper speed limit, and an inter-vehicle distance setting switch which sets a distance between the vehicles.

In a vehicle equipped with the above cruise control system, manual operations on the above-mentioned switches make it possible to adjust the vehicle speed, the inter-vehicle distance, or the like during an automatic cruise control operation. As a result, the driver of the vehicle does not have to operate the accelerator pedal and the brake pedal of the vehicle to adjust the vehicle speed and the inter-vehicle distance, and thereby the work load to the driver is reduced. At the same time, the driver is allowed to intervene in the automatic cruise control operation, for example, by operating the accelerator pedal for acceleration, by operating the brake pedal for deceleration, and by canceling the automatic cruise control operation, so that the driver's intention is appropriately reflected by the vehicle behavior.

However, because the above known cruise control system is configured to aid driving operations under conditions in which the traffic density is relatively low, such as on expressways or highways, or the vehicle speed does not change frequently due to conditions of the roads, it may be difficult to reduce the driver's work load under the conditions in which the traffic is relatively heavy, such as on urban roads, or various road profiles are encountered.

For example, during the automatic cruise control operation, when objects other than a preceding vehicle detected by the radar, the camera, or the like, are encountered, or when the vehicle speed must be frequently changed depending on the road profiles or the like, a problem may be encountered in that the manually operable switches must be frequently operated to change the upper speed limit and the inter-vehicle distance which have been set. Moreover, when the brake pedal is depressed to decrease the vehicle speed at a relatively high rate of deceleration, the automatic cruise control operation may be cancelled, and frequent switching operations may be required to resume the automatic cruise control operation.

Furthermore, because the driver is freed from the accelerator pedal operation during the automatic cruise control operation, fine adjustments of the vehicle speed by operating the accelerator pedal, e.g., an engine brake (compression retarder) operation depending on the driving circumstances, limitation of acceleration with respect to a preceding vehicle, and the like, will not be allowed, and thereby the driver's intention may not be appropriately reflected by the vehicle behavior.

In addition, the driver's work load may be increased because the driver must visually confirm frequently changing operation states of the cruise control system while, at the same time, paying attention to many other vehicles, and to frequently and greatly changing driving conditions, and the like.

### SUMMARY OF THE INVENTION

The present invention was conceived in view of the above circumstances, and an object of the present invention is to provide a drive control apparatus for a vehicle, by which the driver's work load in driving operations can be reduced.

In order to achieve the above object, the present invention provides a drive control apparatus for a vehicle having an accelerator pedal and a brake pedal both of which are operable by a driver of the vehicle, and a power source, the drive control apparatus including: a vehicle speed measuring device which measures a vehicle speed; a control operation switching device which places the drive control apparatus in an operating state upon receiving an operation from the driver; a vehicle speed adjusting device which is placed in an operating state upon receiving a command from the control operation switching device, and which, during the operating state, automatically adjusts the vehicle speed measured by the vehicle speed measuring device, independently from driver's operations of the accelerator pedal and of the brake pedal, so that a target vehicle speed is achieved; and a target vehicle speed changing device which changes the target vehicle speed depending on predetermined driver's operations of the accelerator pedal or of the brake pedal.

According to the drive control apparatus constructed as described above, because the target vehicle speed can be changed depending on the driver's operations of the accelerator pedal or of the brake pedal, the operation state of the drive control operations can be easily changed without executing particular operations just for changing the target vehicle speed, such as operations on switches provided for such a specific purpose.

The above drive control apparatus may further include a target vehicle speed setting device which sets the target vehicle speed depending on driver's operations of the accelerator pedal or of the brake pedal.

According to the drive control apparatus constructed as described above, because the target vehicle speed can be set depending on the driver's operations of the accelerator pedal or of the brake pedal, a desired operation state of the drive control operations can be set without executing particular operations just for setting the target vehicle speed, such as operations on switches provided for such a specific purpose.

The above drive control apparatus may further include an acceleration intention detecting device which determines that the driver intends to increase the target vehicle speed depending on a predetermined operation applied to the accelerator pedal by the driver, and a vehicle speed setting device which sets a new target vehicle speed to be the vehicle speed measured by the vehicle speed measuring device when the driver's intention to increase the target vehicle speed is detected by the acceleration intention detecting device, and the vehicle speed is greater than the target vehicle speed.

According to the drive control apparatus constructed as described above, when the driver's intention to increase the target vehicle speed is detected depending on a predetermined operation applied to the accelerator pedal by the driver, the target vehicle speed is changed; therefore, the driver's intention is appropriately reflected in the drive control operations without executing particular operations just for changing the target vehicle speed, such as operations on switches provided for such a specific purpose.

In the above drive control apparatus, the predetermined operation applied to the accelerator pedal may be defined such that a state, in which a controlled variable for the power source determined depending on a driver's operation applied to the accelerator pedal exceeds a controlled variable for the power source determined by the vehicle speed adjusting device, continues for a predetermined period or longer, and then an amount of depression of the accelerator pedal begins to decrease.

According to the drive control apparatus constructed as described above, when a state, in which a controlled variable for the power source (e.g., an internal combustion engine, a driving electrical motor, etc.) determined depending on a driver's operation applied to the accelerator pedal exceeds a controlled variable for the power source determined by the vehicle speed adjusting device, continues for a predetermined period or longer, it is determined that the driver intends to increase the target vehicle speed during a driving state regulated by the vehicle speed adjusting device, and then, when an amount of depression of the accelerator pedal begins to decrease, it is determined that the driver no longer intends to accelerate, and intends to maintain the driving state at that time. As a result, the driver's intention is appropriately reflected in the drive control operations.

In the above drive control apparatus, the predetermined operation applied to the accelerator pedal may be defined such that a controlled variable for the power source determined depending on a driver's operation applied to the accelerator pedal exceeds a controlled variable for the power source determined by th e vehicle speed adjusting device, by a predetermined amount, and then an amount of depression of the accelerator pedal begins to decrease.

According to the drive control apparatus constructed as described above, when a controlled variable for the power source (e.g., an internal combustion engine, a driving electrical motor, etc.) determined depending on a driver's operation applied to the accelerator pedal exceeds a controlled variable for the power source determined by the vehicle speed adjusting device, by a predetermined amount, it is determined that the driver intends to increase the target vehicle speed during a driving state regulated by the vehicle speed adjusting device, and then, when an amount of depression of the accelerator pedal begins to decrease, it is determined that the driver no longer intends to accelerate, and intends to maintain the driving state at that time. As a result, the driver's intention is appropriately reflected in the drive control operations.

The above drive control apparatus may further include a deceleration intention detecting device which determines that the driver intends to increase the target vehicle speed, and a vehicle speed setting device which sets a new target vehicle speed to be the vehicle speed measured by the vehicle speed measuring device when the driver's intention to decrease the target vehicle speed is detected by the deceleration intention detecting device, and the vehicle speed is less than the target vehicle speed.

According to the drive control apparatus constructed as described above, when the driver's intention to decrease the target vehicle speed is detected depending on a predetermined operation applied to the accelerator pedal by the driver, the target vehicle speed is changed; therefore, the driver's intention is appropriately reflected in the drive control operations without executing particular operations just for changing the target vehicle speed, such as operations on switches provided for such a specific purpose.

In the above drive control apparatus, the deceleration intention detecting device may be adapted to determine that the driver intends to decrease the target vehicle speed when a predetermined operation applied to the accelerator pedal, which is defined such that the accelerator pedal is placed in the OFF state for a predetermined period or longer, and then an amount of depression of the accelerator pedal begins to increase, is detected.

According to the drive control apparatus constructed as described above, when the accelerator pedal is placed in the OFF state for a predetermined period or longer, it is determined that the driver intends to decrease the target vehicle speed during a driving state regulated by the vehicle speed adjusting device, and then, when an amount of depression of the accelerator pedal begins to increase, it is determined that the driver no longer intends to decelerate, and intends to maintain the driving state at that time. As a result, the driver's intention is appropriately reflected in the drive control operations.

In the above drive control apparatus, the deceleration intention detecting device may be adapted to determine that the driver intends to decrease the target vehicle speed when a predetermined operation applied to the accelerator pedal and to the brake pedal, which is defined such that the brake pedal is depressed for a predetermined period or longer, and then an amount of depression of the accelerator pedal begins to increase, is detected.

According to the drive control apparatus constructed as described above, when the brake pedal is placed in the ON state for a predetermined period or longer, it is determined that the driver intends to decrease the target vehicle speed during a driving state regulated by the vehicle speed adjusting device, and then, when an amount of depression of the accelerator pedal begins to increase, it is determined that the driver no longer intends to decelerate, and intends to maintain the driving state at that time. As a result, the driver's intention is appropriately reflected in the drive control operations.

In the above drive control apparatus, the deceleration intention detecting device may be adapted to determine that the driver intends to decrease the target vehicle speed when a predetermined operation applied to the accelerator pedal and to the brake pedal, which is defined such that an amount of depression of the brake pedal is maintained at a predetermined value or greater, and then an amount of depression of the accelerator pedal begins to increase, is detected.

According to the drive control apparatus constructed as described above, when an amount of depression of the brake pedal is maintained at a predetermined value or greater, it is determined that the driver intends to decrease the target vehicle speed during a driving state regulated by the vehicle speed adjusting device, and then, when an amount of depression of the accelerator pedal begins to increase, it is determined that the driver no longer intends to decelerate, and intends to maintain the driving state at that time. As a result, the driver's intention is appropriately reflected in the drive control operations.

The above drive control apparatus may further include an accelerator pedal effort setting device which sets a depressing effort of the accelerator pedal to be greater when the driver depresses the accelerator pedal to obtain a controlled variable for the power source, which is greater than that determined by the vehicle speed adjusting device, than when the vehicle speed adjusting device is not in an operating state.

According to the drive control apparatus constructed as described above, a depressing effort of the accelerator pedal, which is greater than a depressing effort required when the vehicle speed adjusting device is not in an operating state, is required to obtain power output corresponding to a controlled variable for the power source which is greater than a controlled variable determined by the vehicle speed adjusting device; therefore, an excessive power will not be output from the power source even when the accelerator pedal is unnecessarily operated regardless of the driver's intention.

The above drive control apparatus may further include an accelerator pedal effort adjusting device which sets a depressing effort of the accelerator pedal to be less when the driver depresses the accelerator pedal to obtain a controlled variable for the power source, which is less than or equal to that determined by the vehicle speed adjusting device, than when the vehicle speed adjusting device is not in an operating state.

According to the drive control apparatus constructed as described above, when a controlled variable for the power source, which is less than a controlled variable determined by the vehicle speed adjusting device, is to be obtained by operating the accelerator pedal, the accelerator pedal can be operated with a depressing effort which is less than a depressing effort required when the vehicle speed adjusting device is not in an operating state; therefore, an easy operation of the accelerator pedal can be obtained.

Moreover, if the drive control apparatus is constructed such that a greater depressing effort of the accelerator pedal is required when the driver depresses the accelerator pedal to obtain power output corresponding to a controlled variable for the power source, which is greater than that determined by the vehicle speed adjusting device, than when the vehicle speed adjusting device is not in an operating state, the depressing effort of the accelerator pedal changes significantly over the stroke of the accelerator pedal; therefore, the driver can easily perceive the operation state of the drive control operations through the operation of the accelerator pedal.

The present invention further provides a drive control apparatus for a vehicle having an accelerator pedal and a brake pedal both of which are operable by a driver of the vehicle, and a power source, the drive control apparatus including: a vehicle speed measuring device which measures a vehicle speed; an inter-vehicle distance measuring device which measures a distance between the vehicle and a preceding vehicle ahead; a control operation switching device which places the drive control apparatus in an operating state upon receiving an operation from the driver; a vehicle speed adjusting device which is placed in an operating state upon receiving a command from the control operation switching device, and which, during the operating state, automatically adjusts the vehicle speed measured by the vehicle speed measuring device, independently from driver's operations of the accelerator pedal and of the brake pedal, so that a target inter-vehicle distance is achieved; and a target inter-vehicle distance changing device which changes the target inter-vehicle distance depending on predetermined driver's operations of the accelerator pedal or of the brake pedal.

According to the drive control apparatus constructed as described above, because the target inter-vehicle distance can be changed depending on the driver's operations of the accelerator pedal or of the brake pedal, the operation state of the drive control operations can be easily changed without executing particular operations just for changing the target inter-vehicle distance, such as operations on switches provided for such a specific purpose.

The above drive control apparatus may further include a target inter-vehicle distance setting device which sets the target inter-vehicle distance depending on the vehicle speed which is adjusted by the driver's operations of the accelerator pedal or of the brake pedal.

According to the drive control apparatus constructed as described above, because the target inter-vehicle distance can be changed depending on the vehicle speed which is adjusted by the driver's operations of the accelerator pedal or of the brake pedal, the operation state of the drive control operations can be easily set without executing particular operations just for changing the target inter-vehicle distance, such as operations on switches provided for such a specific purpose.

In the above drive control apparatus, the target inter-vehicle distance may include a distance which is required for the vehicle to stop behind the preceding vehicle without a rear-ending accident, and moreover, the target inter-vehicle distance may include a distance to be remained at a stop of the vehicle behind the preceding vehicle.

According to the drive control apparatus constructed as described above, when the vehicle must stop behind a preceding vehicle, a sufficient inter-vehicle distance can be ensured.

The above drive control apparatus may further include an inter-vehicle distance decreasing intention detecting device which determines that the driver intends to decrease the inter-vehicle distance depending on a predetermined driver's operation of the accelerator pedal, and a target inter-vehicle distance decreasing device which decreases the target inter-vehicle distance depending on the inter-vehicle distance measured by the inter-vehicle distance measuring device and on the vehicle speed measured by the vehicle speed measuring device when the driver's intention to decrease the target inter-vehicle distance is detected by the inter-vehicle distance decreasing intention detecting device.

According to the drive control apparatus constructed as described above, when the driver's intention to decrease the inter-vehicle distance is detected depending on a predetermined operation applied to the accelerator pedal by the driver, the target inter-vehicle distance is changed; therefore, the driver's intention is appropriately reflected in the drive control operations without executing particular operations just for changing the target vehicle speed, such as operations on switches provided for such a specific purpose.

The above drive control apparatus may further include an inter-vehicle distance decreasing intention detecting device which determines that the driver intends to decrease the inter-vehicle distance depending on a predetermined driver's operation of the accelerator pedal, and a discrete target inter-vehicle distance setting device which sets the target inter-vehicle distance to be one selected from various discrete values, and the discrete target inter-vehicle distance setting device may be adapted to set the target inter-vehicle distance to be the smallest one among the various discrete values which are greater than or equal to an inter-vehicle distance that is calculated depending on the inter-vehicle distance measured by the inter-vehicle distance measuring device and on the vehicle speed measured by the vehicle speed measuring device.

According to the drive control apparatus constructed as described above, when the driver's intention to decrease the inter-vehicle distance is detected depending on a predetermined operation applied to the accelerator pedal by the driver, the target inter-vehicle distance is changed; therefore, the driver's intention is appropriately reflected in the drive control operations without executing particular operations just for changing the target inter-vehicle distance, such as operations on switches provided for such a specific purpose.

In addition, in a process of decreasing the inter-vehicle distance, the inter-vehicle distance will not be excessively decreased when compared with the driver's intention.

In the above drive control apparatus, the predetermined operation applied to the accelerator pedal may be defined such that a state, in which a controlled variable for the power source determined depending on a driver's operation applied to the accelerator pedal exceeds a controlled variable for the power source determined by the vehicle speed adjusting device, continues for a predetermined period or longer, and then an amount of depression of the accelerator pedal begins to decrease.

According to the drive control apparatus constructed as described above, when a state, in which a controlled variable (e.g., an opening degree of a throttle, electric current supplied to a driving electrical motor, etc.) for the power source (e.g., an internal combustion engine, a driving electrical motor, etc.) determined depending on a driver's operation applied to the accelerator pedal exceeds a controlled variable for the power source determined by the vehicle speed adjusting device, continues for a predetermined period or longer, it is determined that the driver intends to decrease the target inter-vehicle distance during a driving state regulated by the vehicle speed adjusting device, and then, when an amount of depression of the accelerator pedal begins to decrease, it is determined that the driver no longer intends to decrease the target inter-vehicle distance, and intends to maintain the driving state at that time. As a result, the driver's intention is appropriately reflected in the drive control operations.

In the above drive control apparatus, the predetermined operation applied to the accelerator pedal may be defined such that a controlled variable for the power source determined depending on a driver's operation applied to the accelerator pedal exceeds a controlled variable for the power source determined by the vehicle speed adjusting device, by a predetermined amount, and then an amount of depression of the accelerator pedal begins to decrease.

According to the drive control apparatus constructed as described above, when a controlled variable for the power source (e.g., an internal combustion engine, a driving electrical motor, etc.) determined depending on a driver's operation applied to the accelerator pedal exceeds a controlled variable for the power source determined by the vehicle speed adjusting device, by a predetermined amount, it is determined that the driver intends to decrease the target inter-vehicle distance during a driving state regulated by the vehicle speed adjusting device, and then, when an amount of depression of the accelerator pedal begins to decrease, it is determined that the driver no longer intends to decrease the target inter-vehicle distance, and intends to maintain the driving state at that time. As a result, the driver's intention is appropriately reflected in the drive control operations.

The above drive control apparatus may further include an inter-vehicle distance increasing intention detecting device which determines that the driver intends to increase the inter-vehicle distance, and a target inter-vehicle distance increasing device which increases the target inter-vehicle distance depending on the inter-vehicle distance measured by the inter-vehicle distance measuring device and on the vehicle speed measured by the vehicle speed measuring device when the driver's intention to increase the target inter-vehicle distance is detected by the inter-vehicle distance increasing intention detecting device.

According to the drive control apparatus constructed as described above, when the driver's intention to increase the inter-vehicle distance is detected depending on the driver's operations applied to the accelerator pedal or the brake pedal, the target inter-vehicle distance is changed; therefore, the driver's intention is appropriately reflected in the drive control operations without executing particular operations just for changing the target inter-vehicle distance, such as operations on switches provided for such a specific purpose.

The above drive control apparatus may further include an inter-vehicle distance increasing intention detecting device which determines that the driver intends to increase the inter-vehicle distance depending on a predetermined driver's operation of the accelerator pedal, and a discrete target inter-vehicle distance setting device which sets the target inter-vehicle distance to be one selected from various discrete values, and the discrete target inter-vehicle distance setting device may be adapted to set the target inter-vehicle distance to be the smallest one among the various discrete values which are greater than or equal to an inter-vehicle distance that is calculated depending on the inter-vehicle distance measured by the inter-vehicle distance measuring device and on the vehicle speed measured by the vehicle speed measuring device.

According to the drive control apparatus constructed as described above, when the driver's intention to increase the inter-vehicle distance is detected depending on the driver driver's operations applied to the accelerator pedal or the brake pedal, the target inter-vehicle distance is changed; therefore, the driver's intention is appropriately reflected in the drive control operations without executing particular operations just for changing the target inter-vehicle distance, such as operations on switches provided for such a specific purpose.

In addition, in a process of increasing the inter-vehicle distance, an inter-vehicle distance corresponding to the driver's intention to increase the inter-vehicle distance will be reliably ensured.

In the above drive control apparatus, the inter-vehicle distance increasing intention detecting device may be adapted to determine that the driver intends to increase the inter-vehicle distance when a predetermined operation applied to the accelerator pedal, which is defined such that the accelerator pedal is placed in the OFF state for a predetermined period or longer, and then an amount of depression of the accelerator pedal begins to increase, is detected.

According to the drive control apparatus constructed as described above, when a state, in which the accelerator pedal is placed in the OFF state, continues for a predetermined period or longer, it is determined that the driver intends to increase the target inter-vehicle distance during a driving state regulated by the vehicle speed adjusting device, and then, when an amount of depression of the accelerator pedal begins to increase, it is determined that the driver no longer intends to increase the target inter-vehicle distance, and intends to maintain the driving state at that time. As a result, the driver's intention is appropriately reflected in the drive control operations.

In the above drive control apparatus, the inter-vehicle distance increasing intention detecting device may be adapted to determine that the driver intends to increase the inter-vehicle distance when a predetermined operation applied to the accelerator pedal and to the brake pedal, which is defined such that the brake pedal is depressed for a predetermined period or longer, and then an amount of depression of the accelerator pedal begins to increase, is detected.

According to the drive control apparatus constructed as described above, when a state, in which the brake pedal is placed in the ON state, continues for a predetermined period or longer, it is determined that the driver intends to increase the target inter-vehicle distance during a driving state regulated by the vehicle speed adjusting device, and then, when an amount of depression of the accelerator pedal begins to increase, it is determined that the driver no longer intends to increase the target inter-vehicle distance, and intends to maintain the driving state at that time. As a result, the driver's intention is appropriately reflected in the drive control operations.

In the above drive control apparatus, the inter-vehicle distance increasing intention detecting device may be adapted to determine that the driver intends to increase the inter-vehicle distance when a predetermined operation applied to the accelerator pedal and to the brake pedal, which is defined such that an amount of depression of the brake pedal is maintained at a predetermined value or greater, and then an amount of depression of the accelerator pedal begins to increase, is detected.

According to the drive control apparatus constructed as described above, when an amount of depression of the brake pedal is maintained at a predetermined value or greater, it is determined that the driver intends to increase the target inter-vehicle distance during a driving state regulated by the vehicle speed adjusting device, and then, when an amount of depression of the accelerator pedal begins to increase, it is determined that the driver no longer intends to increase the target inter-vehicle distance, and intends to maintain the driving state at that time. As a result, the driver's intention is appropriately reflected in the drive control operations.

### BRIEF DESCRIPTION OF THE DRAWINGS

FIG. 1 is a schematic block diagram showing an embodiment of a drive control apparatus for a vehicle, according to the present invention.

FIG. 2 is a flowchart showing an operation of the drive control apparatus for a vehicle shown in FIG. 1.

FIG. 3 is a flowchart showing an operation for setting a target upper vehicle speed shown in FIG. 2.

FIG. 4 is a flowchart showing an operation for setting a target inter-vehicle distance shown in FIG. 2.

FIG. 5 is a flowchart showing an operation for controlling a throttle and a brake, shown in FIG. 2.

FIG. 6 is a graph showing the relationship between a stroke (an amount of depression) of the accelerator pedal and a reaction force thereof.

FIG. 7 is a graph showing various coefficients for the target inter-vehicle distance, which are set depending on a current vehicle speed “Vnow” and a current inter-vehicle distance “Dnow”.

FIG. 8 is a flowchart showing an operation for controlling the throttle and the brake in another embodiment of the present invention.

### DETAILED DESCRIPTION OF THE INVENTION

An embodiment of a drive control apparatus for a vehicle, according to the present invention, will be explained below with reference to the appended drawings.

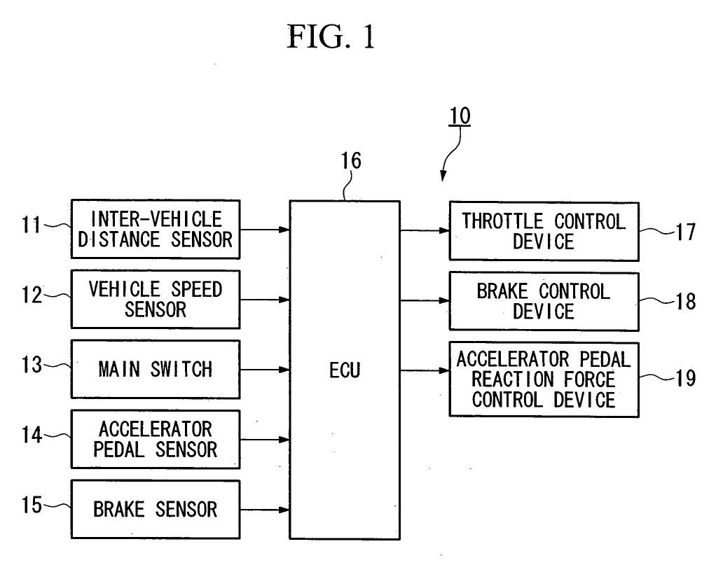

A drive control apparatus 10 for a vehicle in this embodiment constitutes a drive aid apparatus for controlling speed of a vehicle. As shown in FIG. 1, the drive control apparatus 10 includes an inter-vehicle sensor 11, a vehicle speed sensor 12, a main switch 13, an accelerator pedal sensor 14, a brake pedal sensor 15, a control unit (ECU) 16, a throttle control device 17, a brake control device 18, and an accelerator pedal reaction force control device 19.

The inter-vehicle sensor 11 measures an inter-vehicle distance between the vehicle and a preceding vehicle ahead, and sends measured results to the control unit 16.

The vehicle sensor 12 measures the vehicle speed, and sends measured results to the control unit 16.

The main switch 13 sends a command for executing and stopping a drive aid operations upon being placed in the ON state or OFF state by the driver of the vehicle.

The accelerator pedal sensor 14 detects and measures an operation state of the accelerator pedal (not shown) to be operated by the driver, i.e., detects whether the accelerator pedal is in the ON state or OFF state, and measures an amount of depression of the accelerator pedal, and then sends the detected and measured results to the control unit 16.

The brake pedal sensor 15 detects and measures an operation state of the brake pedal (not shown) to be operated by the driver, i.e., detects whether the brake pedal is in the ON state or OFF state, and measures an amount of depression of the brake pedal, and then sends the detected and measured results to the control unit 16.

As will be further explained below, the throttle control device 17 controls an opening degree of the throttle depending on the commands output from the control unit 16, so that the vehicle is accelerated or decelerated.

As will be further explained below, the brake control device 18 controls hydraulic pressure of the brake depending on the commands output from the control unit 16, so that the vehicle is decelerated.

As will be further explained below, the accelerator pedal reaction force control device 19 controls a reaction force of the accelerator pedal with respect to a pedal stroke of the accelerator pedal depending on the commands output from the control unit 16. For example, when the reaction force of the accelerator pedal is increased by the accelerator pedal reaction force control device 19, a greater depressing effort is required for the driver to obtain a desired pedal stroke. The reaction force of the accelerator pedal with respect to the pedal stroke is controlled using, for example, a hydraulic control system which operates depending on the displacement of the accelerator pedal, elements for restricting the displacement of the accelerator pedal, or the like.

Upon receiving a command to start the drive aid operations from the main switch 13 which is turned on by the driver, the control unit 16 determines whether or not a preceding vehicle exists using a radar, a camera, or the like, and when a preceding vehicle is detected, the control unit 16 controls the vehicle so that the vehicle speed is maintained to be a predetermined target upper vehicle speed or less, and the inter-vehicle distance is maintained to be a predetermined target inter-vehicle distance. On the other hand, when a preceding vehicle is not detected, the control unit 16 controls the vehicle so that the vehicle speed is maintained to be the predetermined target upper vehicle speed.

As will be further explained below, the control unit 16 can set and change the target upper vehicle speed and the target inter-vehicle distance depending on predetermined driver's operations of the accelerator pedal or of the brake pedal.

The drive control apparatus 10 according to the present embodiment is constructed as explained above. Next, the operations of the drive control apparatus 10 will be explained below with reference to the appended drawings.

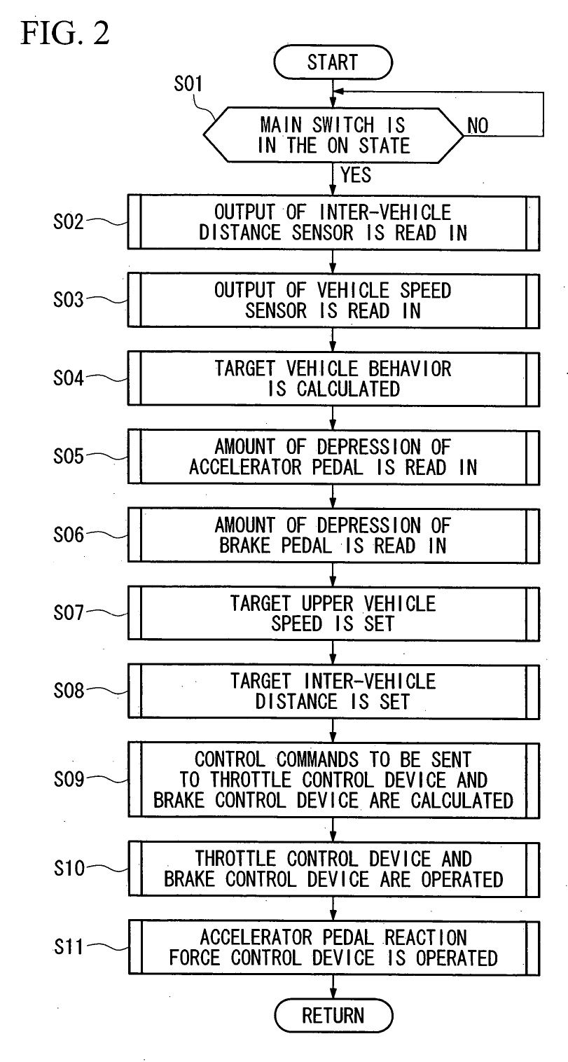

In step S01 shown in FIG. 2, it is determined whether the main switch 13 is turned on by the driver.

When the result of the determination is “NO”, the operation returns to step S01.

In contrast, when the result of the determination is “YES”, the operation proceeds to step S02.

In step S02, the inter-vehicle distance between the vehicle and the preceding vehicle, which is measured by the inter-vehicle sensor 11, is read in. The inter-vehicle sensor 11 determines whether or not a preceding vehicle exists using a radar, a camera, or the like, and when a preceding vehicle is detected, the inter-vehicle sensor 11 measures the distance between the vehicle and the preceding vehicle.

In step S03, the vehicle speed, which is measured by the vehicle speed sensor 12, is read in.

In step S04, a target vehicle behavior including, for example, a target acceleration rate and a target vehicle speed is determined based on a target upper vehicle speed and a target inter-vehicle distance, which will be further explained below, in addition to the inter-vehicle distance obtained in step S02 and the vehicle speed obtained in step S03.

In step S05, the operation state of the accelerator pedal to be operated by the driver, which is detected and measured by the accelerator pedal sensor 14, i.e., whether the accelerator pedal is in the ON state or OFF state and the amount of depression of the accelerator pedal, is read in.

The brake pedal sensor 15 detects and measures an operation state of the brake pedal (not shown) to be operated by the driver, i.e., detects whether the brake pedal is in the ON state or OFF state, and measures an amount of depression of the brake pedal, and then sends the detected and measured results to the control unit 16.

In step S06, the operation state of the brake pedal to be operated by the driver, which is detected and measured by the brake pedal sensor 15, i.e., whether the brake pedal is in the ON state or OFF state and the amount of depression of the brake pedal, is read in.

In step S07, as will be further explained below, the target upper vehicle speed is set depending on a predetermined driver's operations of the accelerator pedal and of the brake pedal.

In step S08, as will be further explained below, the target inter-vehicle distance is set depending on a predetermined driver's operations of the accelerator pedal and of the brake pedal.

In step S09, target values for, for example, the opening degree of the throttle and hydraulic pressure of the brake, i.e., control commands to be sent to the throttle control device 17 and the brake control device 18, are determined so that the vehicle behaves in accordance with the target vehicle behavior.

In step S10, as will be further explained below, the throttle control device 17 and the brake control device 18 are operated in accordance with the determined control commands.

In step S11, the accelerator pedal reaction force control device 19, which controls the reaction force of the accelerator pedal with respect to the pedal stroke of the accelerator pedal, is operated, and the series of the operations is terminated.

Next, the operation for setting the target upper vehicle speed in step S07 will be explained below.

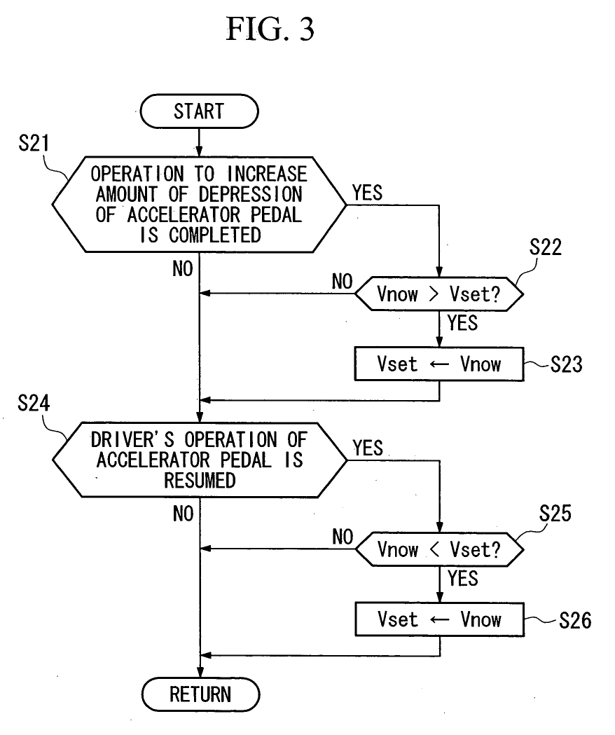

In step S21 shown in FIG. 3, with regard to the driver's operation of the accelerator pedal, it is determined whether an operation to increase the amount of depression of the accelerator pedal is completed. This determination is made, for example, such that a controlled throttle opening “ThCnt”, which is output to the throttle control device 17 independently from the driver's operations of the accelerator pedal and of the brake pedal so that the vehicle behaves in accordance with the target behavior, is compared with a driver-operated throttle opening “ThFoot” which corresponds to the driver's operation of the accelerator pedal.

When the driver's intention to accelerate the vehicle is detected, e.g., when a state, in which the driver-operated throttle opening “ThFoot” is greater than the controlled throttle opening “ThCnt” (i.e., ThFoot>ThCnt), continues for a predetermined period or longer, or when the driver-operated throttle opening “ThFoot” is greater than the controlled throttle opening “ThCnt” by more than a predetermined amount of throttle opening “#ΔTh” (i.e., (ThFoot-ThCnt>#ΔTh)), and consequently, when the amount of depression of the accelerator pedal begins to decrease, it is determined that the operation to increase the amount of depression of the accelerator pedal is completed.

When the result of the determination is “NO”, the operation returns to step S24, which will be explained below.

In contrast, when the result of the determination is “YES”, the operation proceeds to step S22.

In step S22, it is determined whether the current speed of the vehicle “Vnow” measured by the vehicle speed sensor 12 is greater than the target upper vehicle speed “Vset”.

When the result of the determination is “NO”, the operation returns to step S24, which will be explained below.

In contrast, when the result of the determination is “YES”, the operation proceeds to step S23.

In step S23, the target upper vehicle speed “Vset” is set to be the current speed of the vehicle “Vnow”, and the operation proceeds to step S24.

In step S24, it is determined whether the driver's operation of the accelerator pedal is resumed. When the driver's intention to decelerate the vehicle is detected, e.g., when a state, in which the accelerator pedal is placed in the OFF state by the driver, or the brake pedal is placed in the ON state by the driver, continues for a predetermined period or longer, or when the amount of depression of the brake pedal by the driver is greater than a predetermined amount of depression, and consequently, when it is detected that the driver's operation of the accelerator pedal is resumed, or when it is detected that the amount of depression of the accelerator pedal begins to increase, it is determined that the driver's operation of the accelerator pedal is resumed.

When the result of the determination is “NO”, the series of the operations is terminated.

In contrast, when the result of the determination is “YES”, the operation proceeds to step S25.

In step S25, it is determined whether the current speed of the vehicle “Vnow” measured by the vehicle speed sensor 12 is less than the target upper vehicle speed “Vset”.

When the result of the determination is “NO”, the series of the operations is terminated.

In contrast, when the result of the determination is “YES”, the operation proceeds to step S26.

In step S26, the target upper vehicle speed “Vset” is set to be the current speed of the vehicle “Vnow”, and then the series of the operations is terminated.

In step S07 mentioned above, when the main switch 13 is turned on for starting the drive aid operations, the target upper vehicle speed is set to be 0 km/h, and then the target upper vehicle speed is changed depending on the predetermined driver's operations of the accelerator pedal and of the brake pedal through the steps S21 to S26.

Next, the operation for setting the target inter-vehicle distance in step S08 will be explained below.

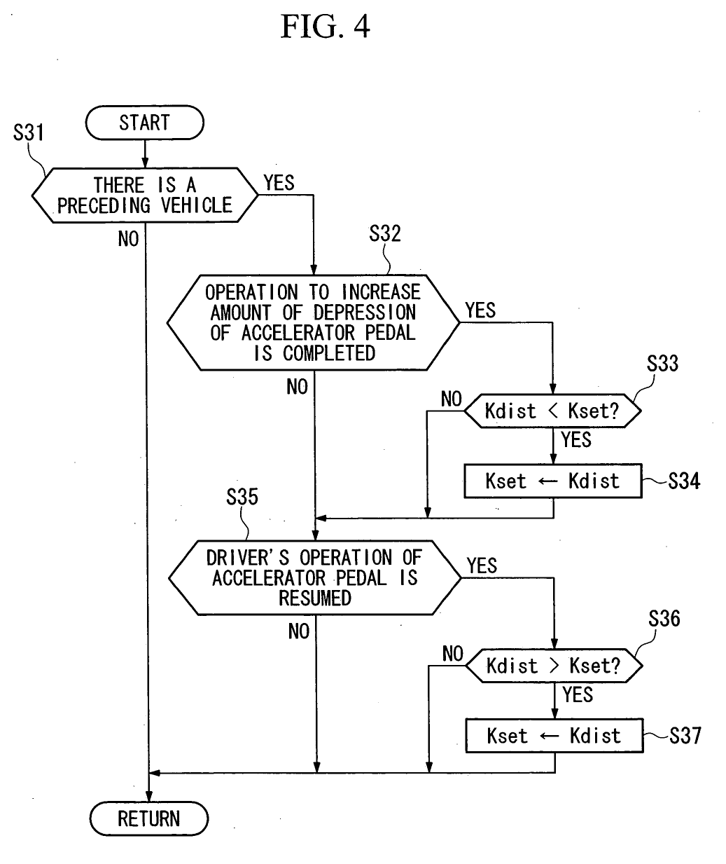

In step S31 shown in FIG. 4, it is determined whether there is a preceding vehicle to follow.

When the result of the determination is “NO”, the series of the operations is terminated.

In contrast, when the result of the determination is “YES”, the operation proceeds to step S32.

In step S32, in a manner similar to step S21 mentioned above, with regard to the driver's operation of the accelerator pedal, it is determined whether an operation to increase the amount of depression of the accelerator pedal is completed. This determination is made, for example, such that a controlled throttle opening “ThCnt”, which is output to the throttle control device 17 independently from the driver's operations of the accelerator pedal and of the brake pedal so that the vehicle behaves in accordance with the target behavior, is compared with a driver-operated throttle opening “ThFoot” which corresponds to the driver's operation of the accelerator pedal.

When the driver's intention to accelerate the vehicle is detected, e.g., when a state, in which the driver-operated throttle opening “ThFoot” is greater than the controlled throttle opening “ThCnt” (i.e., ThFoot>ThCnt), continues for a predetermined period or longer, or when the driver-operated throttle opening “ThFoot” is greater than the controlled throttle opening “ThCnt” by more than a predetermined amount of throttle opening “#ΔTh” (i.e., (ThFoot-ThCnt)>#ΔTh), and consequently, when the amount of depression of the accelerator pedal begins to decrease, it is determined that the operation to increase the amount of depression of the accelerator pedal is completed.

When the result of the determination is “NO”, the operation returns to step S35, which will be explained below.

In contrast, when the result of the determination is “YES”, the operation proceeds to step S33.

In step S33, it is determined whether an inter-vehicle setting value, which corresponds to the current inter-vehicle distance measured by the inter-vehicle distance sensor 11, e.g., a target inter-vehicle distance coefficient “Kdist” calculated using Equation (1) shown below, is smaller than a predetermined target inter-vehicle distance setting value “Kset”.

Kdist=(Dnow-OFFSET)/Vnow (1)

In Equation (1), the target inter-vehicle distance coefficient “Kdist” is time required for the vehicle to run, at the current vehicle speed “Vnow” measured by the vehicle speed sensor 12, over a distance which is obtained by subtracting a predetermined inter-vehicle distance margin “OFFSET” (e.g., an inter-vehicle distance between the vehicle and a preceding vehicle when the vehicle stops behind the preceding vehicle) from the current inter-vehicle distance measured by the inter-vehicle distance sensor 11.

When the result of the determination is “NO”, the operation returns to step S35, which will be explained below.

In contrast, when the result of the determination is “YES”, the operation proceeds to step S34.

In step S34, the target inter-vehicle distance setting value “Kset” is set to be the target inter-vehicle distance coefficient “Kdist”, and the operation proceeds to step S35.

In step S35, in a manner similar to step S24 mentioned above, it is determined whether the driver's operation of the accelerator pedal is resumed. When the driver's intention to increase the inter-vehicle distance is detected, e.g., with regard to the driver's operations of the accelerator pedal and of the brake pedal, when a state, in which the accelerator pedal is placed in the OFF state by the driver, or the brake pedal is placed in the ON state by the driver, continues for a predetermined period or longer, or, with regard to the driver's operation of the brake pedal, when the amount of depression of the brake pedal by the driver is greater than a predetermined amount of depression, and consequently, when it is detected that the driver's operation of the accelerator pedal is resumed, or when it is detected that the amount of depression of the accelerator pedal begins to increase, it is determined that the driver's operation of the accelerator pedal is resumed.

When the result of the determination is “NO”, the series of the operations is terminated.

In contrast, when the result of the determination is “YES”, the operation proceeds to step S36.

In step S36, it is determined whether an inter-vehicle setting value, which corresponds to the current inter-vehicle distance measured by the inter-vehicle distance sensor 11, e.g., the target inter-vehicle distance coefficient “Kdist” calculated using Equation (1) shown above, is greater than the predetermined target inter-vehicle distance setting value “Kset”.

When the result of the determination is “NO”, the series of the operations is terminated.

In contrast, when the result of the determination is “YES”, the operation proceeds to step S37.

In step S37, the target inter-vehicle distance setting value “Kset” is set to be the target inter-vehicle distance coefficient “Kdist”, and the series of the operations is terminated.

In step S08 mentioned above, at the beginning of the drive aid operations, the target inter-vehicle distance is set to be the current inter-vehicle distance measured by the inter-vehicle distance sensor 11, and then the target inter-vehicle distance is changed depending on the predetermined driver's operations of the accelerator pedal and of the brake pedal through the steps S31 to S37.

Next, the throttle control operation and the brake control operation in step S10 mentioned above will be explained below.

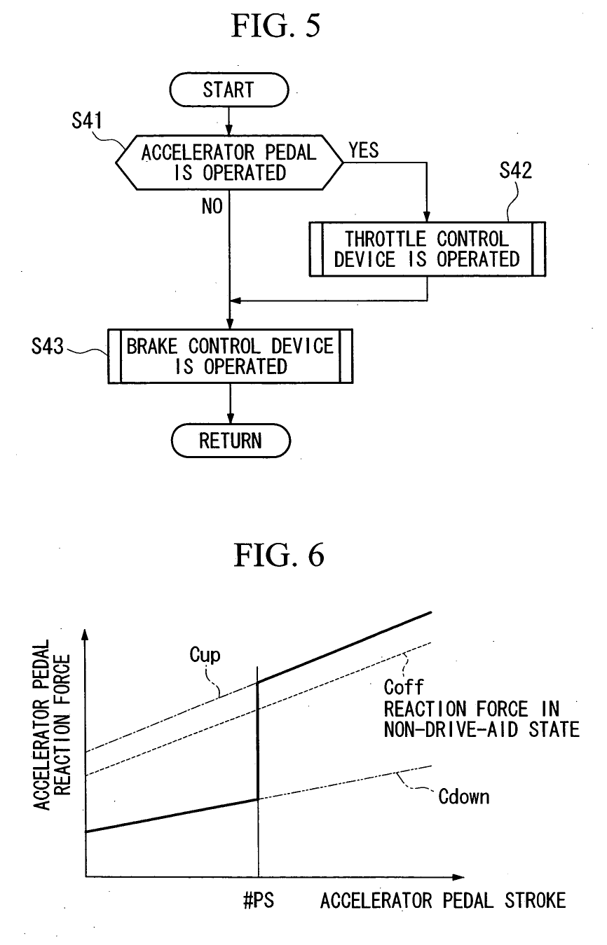

In step S41 shown in FIG. 5, it is determined whether the accelerator pedal is operated by the driver.

When the result of the determination is “YES”, the operation proceeds to step S42.

In contrast, when the result of the determination is “NO”, the operation proceeds to step S43.

In step S42, the throttle control device 17 is allowed to execute the throttle control operation, and the operation proceeds to step S43.

In step S43, the brake control device 18 is allowed to execute the brake control operation, and the series of the operations is terminated.

In other words, in step S10, the throttle control operation executed by the throttle control device 17, as a part of the drive aid operations, is allowed only when the accelerator pedal is operated by the driver.

On the other hand, the brake control operation executed by the brake control device 18, as a part of the drive aid operations, is allowed regardless of the driver's operations of the accelerator pedal and of the brake pedal.

Next, the control operation for the reaction force of the accelerator pedal with respect to the pedal stroke of the accelerator pedal in step S11 mentioned above will be explained below.

In this embodiment, when the accelerator pedal is operated by the driver during the throttle control operation executed by the throttle control device 17 as a part of the drive aid operations, a stroke-dependent characteristic of the reaction force of the accelerator pedal in a state, in which the pedal stroke achieved by the driver's operation of the accelerator pedal is less than that corresponding to a throttle opening achieved by the throttle control operation, differs from that in a state in which the pedal stroke achieved by the driver's operation of the accelerator pedal is greater than or equal to that corresponding to a throttle opening achieved by the throttle control operation.

As shown in FIG. 6, for example, the reaction force of the accelerator pedal is set so as to increase in accordance with the pedal stroke achieved by the driver's operation of the accelerator pedal, and more specifically, the reaction force is set so as to increase in proportion with the pedal stroke. When compared with the reaction force depending on the pedal stroke in a state in which the drive aid operations are not executed (e.g., a reaction force in a non-drive-aid state “Coff” shown in FIG. 6), a greater reaction force (e.g., a reaction force “Cup” shown in FIG. 6) is set on the one hand, and a less reaction force (e.g., a reaction force “Cdown” shown in FIG. 6) is set on the other hand.

More specifically, in the case in which the pedal stroke achieved by the driver's operation of the accelerator pedal is less than the pedal stroke (e.g., a pedal stroke “#PS” shown in FIG. 6) corresponding to a throttle opening achieved by the throttle control operation, a reaction force (e.g., the reaction force “Cdown” shown in FIG. 6), which is less the reaction force depending on the pedal stroke in a state in which the drive aid operations are not executed (e.g., a reaction force in a non-drive-aid state “Coff” shown in FIG. 6), is set. On the other hand, in the case in which the pedal stroke achieved by the driver's operation of the accelerator pedal is greater than the pedal stroke (e.g., the pedal stroke “#PS” shown in FIG. 6) corresponding to a throttle opening achieved by the throttle control operation, a reaction force (e.g., the reaction force “Cup” shown in FIG. 6), which is greater than or equivalent to the reaction force depending on the pedal stroke in a state in which the drive aid operations are not executed (e.g., the reaction force in a non-drive-aid state “Coff” shown in FIG. 6), is set.

As a result, for example, during a state in which the pedal stroke achieved by the driver's operation of the accelerator pedal is increasing, the reaction force of the accelerator pedal increases with a step when the pedal stroke achieved by the driver's operation reaches the pedal stroke (e.g., the pedal stroke “#PS” shown in FIG. 6) corresponding to a throttle opening achieved by the throttle control operation. Accordingly, the driver must depress the accelerator pedal with a significantly greater force in order to further increase the pedal stroke beyond the pedal stroke corresponding to a throttle opening achieved by the throttle control operation. As constructed in this manner, when the driver relaxedly places the foot on the accelerator pedal, the accelerator pedal may be used as a footrest because the accelerator pedal will not be depressed beyond the pedal stroke corresponding to a throttle opening achieved by the throttle control operation.

As explained above, according to the drive control apparatus 10 for a vehicle in the above embodiment, the target upper vehicle speed and the target inter-vehicle distance can be set in accordance with the driver's operations of the accelerator pedal and of the brake pedal; therefore, a desired operation state of the drive control operations can be set and changed without executing particular operations just for setting and changing the target upper vehicle speed and the target inter-vehicle distance.

In addition, because the driver's intention to accelerate, to decelerate, to decrease the inter-vehicle distance, or to increase the inter-vehicle distance can be detected depending on the predetermined driver's operations of the accelerator pedal and of the brake pedal, the driver's intention is appropriately reflected in the drive control operations.

Moreover, because the stroke-dependent characteristic of the reaction force of the accelerator pedal differently set depending on whether or not the pedal stroke achieved by the driver's operation of the accelerator pedal is less than that corresponding to a throttle opening achieved by the throttle control operation, an excessive power will not be output from the power source even when the accelerator pedal is unnecessarily operated regardless of the driver's intention. Furthermore, the driver can easily perceive the operation state of the drive control operations through the operation of the accelerator pedal.

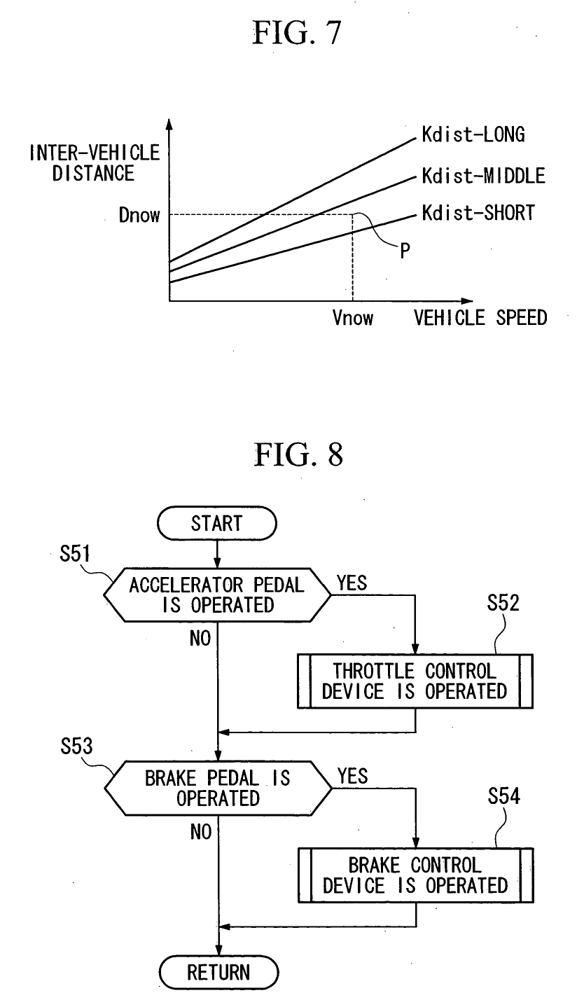

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims. For example, in the above embodiment, the target inter-vehicle distance coefficient “Kdist” is calculated using Equation (1) in step S33; however, the present invention is not limited to this. As shown in FIG. 7, various predetermined target inter-vehicle coefficients “Kdist” (e.g., “Kdist-long”, “Kdist-middle”, and “Kdist-short”, shown in FIG. 7), which differ from each other, may be set in accordance with the current vehicle speed “Vnow” measured by the vehicle speed sensor 12 and on the current inter-vehicle distance “Dnow” measured by the inter-vehicle distance sensor 11, and one of the target inter-vehicle coefficients “Kdist” may be selected depending on the current vehicle speed “Vnow” and the current inter-vehicle distance “Dnow”.

When one of the target inter-vehicle coefficients “Kdist” is selected, a smallest one should be selected among the coefficients which are greater than or equal to the coefficient “Kdist” calculated using Equation (1) depending on the current vehicle speed “Vnow” and the current inter-vehicle distance “Dnow”.

For example, as shown in FIG. 7, when the target inter-vehicle coefficient “Kdist” corresponding to a state P, which is defined by the current vehicle speed “Vnow” and the current inter-vehicle distance “Dnow”, falls between the “Kdist-middle” and the “Kdist-short”, the “Kdist-middle” is selected.

As a result, when the inter-vehicle distance is to be decreased, the inter-vehicle distance will not be excessively decreased, and when the inter-vehicle distance is to be increased, an inter-vehicle distance corresponding to the driver's intention to increase the inter-vehicle distance will be reliably ensured.

Moreover, in the above embodiment, the brake control operation executed by the brake control device 18, as a part of the drive aid operations, is allowed regardless of the driver's operations of the accelerator pedal and of the brake pedal in step S10; however, the present invention is not limited to this. For example, as shown in FIG. 8, the drive control apparatus may be configured such that the brake control operation executed by the brake control device 18 is allowed only when the brake pedal is operated by the driver.

In step S51 shown in FIG. 8, it is determined whether the accelerator pedal is operated by the driver.

When the result of the determination is “YES”, the operation proceeds to step S52.

In contrast, when the result of the determination is “NO”, the operation proceeds to step S53.

In step S52, the throttle control device 17 is allowed to execute the throttle control operation, and the operation proceeds to step S53.

In step S53, it is determined whether the brake pedal is operated by the driver.

When the result of the determination is “YES”, the operation proceeds to step S54.

In contrast, when the result of the determination is “NO”, the series of the operations is terminated.

In step S54, the brake control device 18 is allowed to execute the brake control operation, and the series of the operations is terminated.

Advantageous Effects Obtainable by the Invention

As explained above, according to the drive control apparatus of the present invention, the operation state of the drive control operations can be easily changed in accordance with the driver's operations of the accelerator pedal or of the brake pedal without executing particular operations just for changing the target vehicle speed, such as operations on switches provided for such a specific purpose.

According to another drive control apparatus of the present invention, a desired operation state of the drive control operations can be set without executing particular operations just for setting the target vehicle speed, such as operations on switches provided for such a specific purpose.

According to another drive control apparatus of the present invention, the driver's intention is appropriately reflected in the drive control operations without executing particular operations just for changing the target vehicle speed, such as operations on switches provided for such a specific purpose.

According to another drive control apparatus of the present invention, the operation state of the drive control operations can be easily changed in accordance with the driver's operations of the accelerator pedal or of the brake pedal without executing particular operations just for changing the inter-vehicle distance, such as operations on switches provided for such a specific purpose.

According to another drive control apparatus of the present invention, a desired operation state of the drive control operations can be set without executing particular operations just for setting the inter-vehicle distance, such as operations on switches provided for such a specific purpose.

According to another drive control apparatus of the present invention, when the vehicle must stop behind a preceding vehicle, a sufficient inter-vehicle distance can be ensured.

According to another drive control apparatus of the present invention, the driver's intention is appropriately reflected in the drive control operations without executing particular operations just for changing the inter-vehicle distance, such as operations on switches provided for such a specific purpose.

According to another drive control apparatus of the present invention, in a process of decreasing the inter-vehicle distance, the inter-vehicle distance will not be excessively decreased when compared with the driver's intention.

According to another drive control apparatus of the present invention, an inter-vehicle distance corresponding to the driver's intention to increase the inter-vehicle distance will be reliably ensured.

According to another drive control apparatus of the present invention, an excessive power will not be output from the power source even when the accelerator pedal is unnecessarily operated regardless of the driver's intention.

According to another drive control apparatus of the present invention, the depressing effort of the accelerator pedal changes significantly over the stroke of the accelerator pedal; therefore, the driver can easily perceive the operation state of the drive control operations through the operation of the accelerator pedal.

What is claimed is:

1. A drive control apparatus for a vehicle having an accelerator pedal and a brake pedal both of which are operable by a driver of the vehicle, and a power source, the drive control apparatus comprising:
a vehicle speed measuring device which measures a vehicle speed;
a control operation switching device which places the drive control apparatus in an operating state upon receiving an operation from the driver;
a vehicle speed adjusting device which is placed in an operating state upon receiving a command from the control operation switching device, and which, during the operating state, automatically adjusts the vehicle speed measured by the vehicle speed measuring device, independently from driver's operations of the accelerator pedal and of the brake pedal, so that a target vehicle speed is achieved; and
a target vehicle speed changing device which changes the target vehicle speed depending on predetermined driver's operations of the accelerator pedal or of the brake pedal.

2. A drive control apparatus according to claim 1, further comprising:
a target vehicle speed setting device which sets the target vehicle speed depending on driver's operations of the accelerator pedal or of the brake pedal.

3. A drive control apparatus according to claim 1, further comprising:
an acceleration intention detecting device which determines that the driver intends to increase the target vehicle speed depending on a predetermined operation applied to the accelerator pedal by the driver; and
a vehicle speed setting device which sets a new target vehicle speed to be the vehicle speed measured by the vehicle speed measuring device when the driver's intention to increase the target vehicle speed is detected by the acceleration intention detecting device, and the vehicle speed is greater than the target vehicle speed.

4. A drive control apparatus according to claim 3, wherein the predetermined operation applied to the accelerator pedal is defined such that a state, in which a controlled variable for the power source determined depending on a driver's operation applied to the accelerator pedal exceeds a controlled variable for the power source determined by the vehicle speed adjusting device, continues for a predetermined period or longer, and then an amount of depression of the accelerator pedal begins to decrease.

5. A drive control apparatus according to claim 3, wherein the predetermined operation applied to the accelerator pedal is defined such that a controlled variable for the power source determined depending on a driver's operation applied to the accelerator pedal exceeds a controlled variable for the power source determined by the vehicle speed adjusting device, by a predetermined amount, and then an amount of depression of the accelerator pedal begins to decrease.

6. A drive control apparatus according to claim 1, further comprising:
a deceleration intention detecting device which determines that the driver intends to increase the target vehicle speed; and
a vehicle speed setting device which sets a new target vehicle speed to be the vehicle speed measured by the vehicle speed measuring device when the driver's intention to decrease the target vehicle speed is detected by the deceleration intention detecting device, and the vehicle speed is less than the target vehicle speed.

7. A drive control apparatus according to claim 6, wherein the deceleration intention detecting device determines that the driver intends to decrease the target vehicle speed when a predetermined operation applied to the accelerator pedal, which is defined such that the accelerator pedal is placed in an OFF state for a predetermined period or longer, and then an amount of depression of the accelerator pedal begins to increase, is detected.

8. A drive control apparatus according to claim 6, wherein the deceleration intention detecting device determines that the driver intends to decrease the target vehicle speed when a predetermined operation applied to the accelerator pedal and to the brake pedal, which is defined such that the brake pedal is depressed for a predetermined period or longer, and then an amount of depression of the accelerator pedal begins to increase, is detected.

9. A drive control apparatus according to claim 6, wherein the deceleration intention detecting device determines that the driver intends to decrease the target vehicle speed when a predetermined operation applied to the accelerator pedal and to the brake pedal, which is defined such that an amount of depression of the brake pedal is maintained at a predetermined value or greater, and then an amount of depression of the accelerator pedal begins to increase, is detected.

10. A drive control apparatus according to claim 1, further comprising:
an accelerator pedal effort setting device which sets a depressing effort of the accelerator pedal to be greater when the driver depresses the accelerator pedal to obtain a controlled variable for the power source, which is greater than that determined by the vehicle speed adjusting device, than when the vehicle speed adjusting device is not in an operating state.

11. A drive control apparatus according to claim 1, further comprising: an accelerator pedal effort adjusting device which sets a depressing effort of the accelerator pedal to be less when the driver depresses the accelerator pedal to obtain a controlled variable for the power source, which is less than or equal to that determined by the vehicle speed adjusting device, than when the vehicle speed adjusting device is not in an operating state.

12. A drive control apparatus for a vehicle having an accelerator pedal and a brake pedal both of which are operable by a driver of the vehicle, and a power source, the drive control apparatus comprising:
a vehicle speed measuring device which measures a vehicle speed;
an inter-vehicle distance measuring device which measures a distance between the vehicle and a preceding vehicle ahead;
a control operation switching device which places the drive control apparatus in an operating state upon receiving an operation from the driver;
a vehicle speed adjusting device which is placed in an operating state upon receiving a command from the control operation switching device, and which, during the operating state, automatically adjusts the vehicle speed measured by the vehicle speed measuring device, independently from driver's operations of the accelerator pedal and of the brake pedal, so that a target inter-vehicle distance is achieved; and
a target inter-vehicle distance changing device which changes the target inter-vehicle distance depending on predetermined driver's operations of the accelerator pedal or of the brake pedal.

13. A drive control apparatus according to claim 12, further comprising:
a target inter-vehicle distance setting device which sets the target inter-vehicle distance depending on the vehicle speed which is adjusted by driver's operations of the accelerator pedal or of the brake pedal.

14. A drive control apparatus according to claim 12, wherein the target inter-vehicle distance includes a distance which is required for the vehicle to stop behind the preceding vehicle without a rear-ending accident.

15. A drive control apparatus according to claim 12, wherein the target inter-vehicle distance includes a distance to be remained at a stop of the vehicle behind the preceding vehicle.

16. A drive control apparatus according to claim 12, further comprising:
an inter-vehicle distance decreasing intention detecting device which determines that the driver intends to decrease the inter-vehicle distance depending on a predetermined driver's operation of the accelerator pedal; and
a target inter-vehicle distance decreasing device which decreases the target inter-vehicle distance depending on the inter-vehicle distance measured by the inter-vehicle distance measuring device and on the vehicle speed measured by the vehicle speed measuring device when the driver's intention to decrease the target inter-vehicle distance is detected by the inter-vehicle distance decreasing intention detecting device.

17. A drive control apparatus according to claim 12, further comprising:
an inter-vehicle distance decreasing intention detecting device which determines that the driver intends to decrease the inter-vehicle distance depending on a predetermined driver's operation of the accelerator pedal; and
a discrete target inter-vehicle distance setting device which sets the target inter-vehicle distance to be one selected from various discrete values,
wherein the discrete target inter-vehicle distance setting device sets the target inter-vehicle distance to be the smallest one among the various discrete values which are greater than or equal to an inter-vehicle distance that is calculated depending on the inter-vehicle distance measured by the inter-vehicle distance measuring device and on the vehicle speed measured by the vehicle speed measuring device.

18. A drive control apparatus according to claim 16, wherein the predetermined operation applied to the accelerator pedal is defined such that a state, in which a controlled variable for the power source determined depending on a driver's operation applied to the accelerator pedal exceeds a controlled variable for the power source determined by the vehicle speed adjusting device, continues for a predetermined period or longer, and then an amount of depression of the accelerator pedal begins to decrease.

19. A drive control apparatus according to claim 16, wherein the predetermined operation applied to the accelerator pedal is defined such that a controlled variable for the power source determined depending on a driver's operation applied to the accelerator pedal exceeds a controlled variable for the power source determined by the vehicle speed adjusting device, by a predetermined amount, and then an amount of depression of the accelerator pedal begins to decrease.

20. A drive control apparatus according to claim 12, further comprising:
an inter-vehicle distance increasing intention detecting device which determines that the driver intends to increase the inter-vehicle distance; and
a target inter-vehicle distance increasing device which increases the target inter-vehicle distance depending on the inter-vehicle distance measured by the inter-vehicle distance measuring device and on the vehicle speed measured by the vehicle speed measuring device when the driver's intention to increase the target inter-vehicle distance is detected by the inter-vehicle distance increasing intention detecting device.

21. A drive control apparatus according to claim 12, further comprising:
an inter-vehicle distance increasing intention detecting device which determines that the driver intends to increase the inter-vehicle distance depending on a predetermined driver's operation of the accelerator pedal; and
a discrete target inter-vehicle distance setting device which sets the target inter-vehicle distance to be one selected from various discrete values,
wherein the discrete target inter-vehicle distance setting device sets the target inter-vehicle distance to be the smallest one among the various discrete values which are greater than or equal to an inter-vehicle distance that is calculated depending on the inter-vehicle distance measured by the inter-vehicle distance measuring device and on the vehicle speed measured by the vehicle speed measuring device.

22. A drive control apparatus according to claim 20, wherein the inter-vehicle distance increasing intention detecting device determines that the driver intends to increase the inter-vehicle distance when a predetermined operation applied to the accelerator pedal, which is defined such that the accelerator pedal is placed in an OFF state for a predetermined period or longer, and then an amount of depression of the accelerator pedal begins to increase, is detected.

23. A drive control apparatus according to claim 20, wherein the inter-vehicle distance increasing intention detecting device determines that the driver intends to increase the inter-vehicle distance when a predetermined operation applied to the accelerator pedal and to the brake pedal, which is defined such that the brake pedal is depressed for a predetermined period or longer, and then an amount of depression of the accelerator pedal begins to increase, is detected.

24. A drive control apparatus according to claim 20, wherein the inter-vehicle distance increasing intention detecting device determines that the driver intends to increase the inter-vehicle distance when a predetermined operation applied to the accelerator pedal and to the brake pedal, which is defined such that an amount of depression of the brake pedal is maintained at a predetermined value or greater, and then an amount of depression of the accelerator pedal begins to increase, is detected.

25. A drive control apparatus according to claim 12, further comprising:
an accelerator pedal effort setting device which sets a depressing effort of the accelerator pedal to be greater when the driver depresses the accelerator pedal to obtain a controlled variable for the power source, which is greater than that determined by the vehicle speed adjusting device, than when the vehicle speed adjusting device is not in an operating state.

26. A drive control apparatus according to claim 12, further comprising:
an accelerator pedal effort adjusting device which sets a depressing effort of the accelerator pedal to be less when the driver depresses the accelerator pedal to obtain a controlled variable for the power source, which is less than or equal to that determined by the vehicle speed adjusting device, than when the vehicle speed adjusting device is not in an operating state.
